(19) United States
(12) Patent Application Publication
(10) Pub. No.: US 2023/0029777 A1
(43) Pub. Date: Feb. 2, 2023

(54) INTRA TRANSACTION ITEM-BASED SEQUENCE MODELING FOR FRAUD DETECTION

(71) Applicant: NCR Corporation, Atlanta, GA (US)

(72) Inventors: Shiran Abadi, Tel-Aviv (IL); Itamar David Laserson, Givat Shmuel (IL); Amit Botzer, Haifa (IL)

(21) Appl. No.: 17/389,476

(22) Filed: Jul. 30, 2021

(51) Int. Cl. G06Q 20/40; G06N 20/00; G06Q 20/08; G06Q 20/20

(52) U.S. Cl. CPC G06Q 20/4016; G06N 20/00; G06Q 20/085; G06Q 20/4014; G06Q 20/202; G06Q 20/18

(57) ABSTRACT

The probabilities of transitioning between item states for a given item sequence of a given transaction are calculated and item non-fraud scores are calculated from the probabilities for each item of the given transaction. The item non-fraud scores for the items of the transaction are provided to a fraud-detection system for determining whether any of the item non-fraud scores is more likely or less likely to be associated with sweethearting fraud by a cashier that performed the transaction.

### BACKGROUND

Sweethearting is one of the most prevalent types of fraud experienced by retailers. In a recent study that analyzed the role of sweethearting in employee theft among approximately 800 retail service employees and customers survey, 67% said that they had participated in sweethearting in the past two months. It is estimated that sweethearting contributes to an annual loss of nearly $50 billion for U.S. retailers.

Sweethearting is a form of theft performed by a cashier, where the cashier gives away merchandise or discounts to a “sweetheart” customer (such as a friend, a family member, or a fellow member). Sweethearting can take several forms; for example, not scanning an item during checkout (scan avoidance), changing the price of an item (price override), or voiding an item after scanning it.

Current techniques to detect sweethearting are ineffective in identifying suspicious activities during a transaction. Attempting to differentiate between a legitimate action during a transaction versus a sweethearting-driven action is challenging and hard to uncover without close and real-time inspection and monitoring.

It is infeasible to to have remote staff monitor real-time video of cashiers for sweethearting activities; this would require a single remote monitoring person for each cashier, since an individual realistically cannot monitor more than one transaction at a time.

Additionally, although real-time video analysis and tracking has made substantial advancements in recent years, cashiers are often aware of what is being monitored and can fool such systems (such as by avoiding or blocking a particular field of view of a monitoring camera). Furthermore, real-time video analysis systems are expensive to deploy and often require integration with a retailer's transaction system to be effective (to identify the transaction events being raised by the transaction terminal operated by the cashier during a checkout; the transaction events are then correlated with detected real-time video events). As a result, few retailers have deployed effective real-time video analysis systems to catch sweethearting activities during checkouts.

### SUMMARY

In various embodiments, system and a method for intra transaction item-based sequence modeling for fraud detection are presented.

According to an aspect, a method for intra transaction item-based sequence modeling for fraud detection is presented. An item identifier for an item, item events for the item, and actions on other items that are relevant to the item are received for a transaction at a transaction terminal. An item non-fraud score is calculated for the item based on a sequence of the events for the transaction. The item non-fraud score is provided to a fraud detection system for further fraud evaluation based on the item non-fraud score.

### BRIEF DESCRIPTION OF THE DRAWINGS

FIG. 1 is a diagram of a system for intra transaction item-based sequence modeling for fraud detection, according to an example embodiment.

FIG. 2 is a diagram of a method for intra transaction item-based sequence modeling for fraud detection, according to an example embodiment.

FIG. 3 is a diagram of another method for intra transaction item-based sequence modeling for fraud detection, according to an example embodiment.

### DETAILED DESCRIPTION

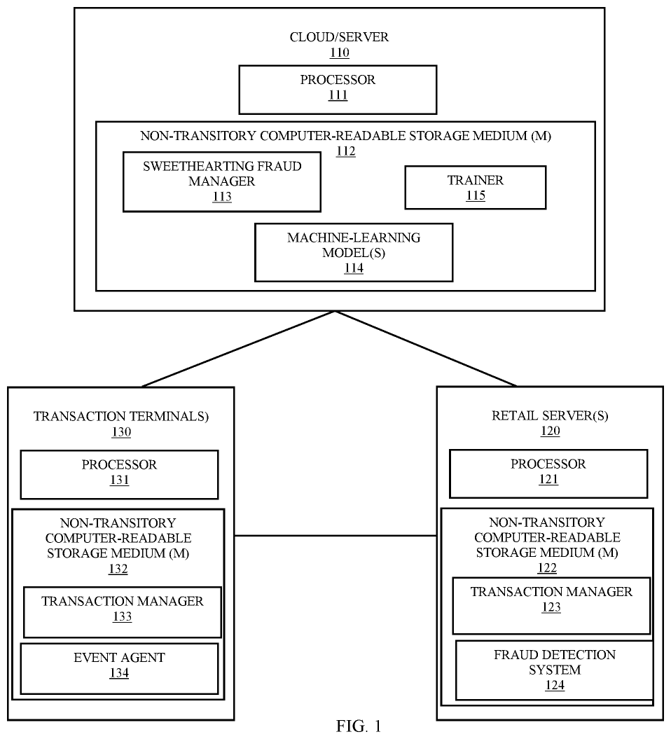

FIG. 1 is a diagram of a system 100 for intra transaction item-based sequence modeling for fraud detection, according to an example embodiment. It is to be noted that the components are shown schematically in greatly simplified form, with only those components relevant to understanding of the embodiments being illustrated.

Furthermore, the various components (that are identified in FIG. 1) are illustrated and the arrangement of the components is presented for purposes of illustration only. It is to be noted that other arrangements with more or less components are possible without departing from the teachings of intra transaction item-based sequence modeling for fraud detection presented herein and below.

System 100 and the techniques that follow model the activities or states of each item during a given transaction. The model assigns a calculated probability that a given item in a given state transitions to a next state from the given state. Each item state can transition to any remaining item state, each potential transition is assigned its own calculated probability when a cashier/operator during a check performs an action that moves a given item state to a specific transitioned next item state, the model assigns the corresponding probability for that transition. The probabilities for the states of a given item is used by the model to produce a single item non-fraud score for the transaction. Each item non-fraud score of the transaction is combined to form an overall transaction non-fraud score. The sequence of actions/states taken by the cashier on each item of the transaction provides a good indicator as to whether or not sweethearting fraud is present in the transaction and/or present with a specific item of the transaction.

The model permits evaluation of the sequence of actions occurring before and subsequent to any sweethearting fraud, which quantifies and yields reliable objective information (via the item non-fraud scores and overall transaction non-fraud score) as to whether fraud was present or not for a given transaction and/or a given item of the given transaction.

For example, a void is a valid action for canceling an item that has already been scanned but turns out to be unwanted by a customer during checkout, possibly due to an unexpected high item price. Typically, the customer will notice the item soon after the cashier scans it. However, void actions occurring at the end of a transaction are more likely to indicate an item being voided to reduce the total transaction amount, which raises the risk for fraudulent activity especially when there are multiple item voids for the transaction or voids of high-priced items for the transaction. The model accounts for these situations.

In another case, a price override is also often a legitimate cashier action when the observed tag price of an item is higher than the scanned catalogue price for the item during a checkout or when a promotion discount was not received. Again, customers typically notice this price discrepancy soon after the item is scanned during checkout. So, the longer period of time after the item is scanned during the transaction before the cashier performs a price override for the item, the more likely the cashier action is related to fraud. The model accounts for this case.

In still another situation, when a weighted item is first identified by the cashier, then voided, and another-lower priced item is identified with the exact same weight, there is an increased risk that the cashier is selling a higher-priced item by identifying it as a different lower-priced item during checkout. The model accounts for this situation.

In yet another circumstance, when an item is neither voided, overridden, nor weighted, a given cashier's item scan rate is remarkably constant. Such that when a time lag in the cashier's scan rate ends up being equal to a multiplication of the expected base scan rate for the cashier, cashier scan avoidance can often be implied as being present during checkout. The model accounts for this circumstance.

The trained model infers a likelihood score for a sequence of actions (states) that are performed by an operator during a single given transaction while the model also accounts for relationships between the actions/states performed on a same item. The model identifies that a risky sequence of actions on an item within a transaction (intra transaction) is unlikely to happen by producing a lower item non-fraud score (low probability).

The model utilizes a graph for each item within a transaction (intra transaction). Every vertex (node) in the graph represents an action per item (as a state) and the edges represent the transition from one state (action on the item) to another state (next action on the item). Each vertex represents one of all possible/available actions/states, such as a standard item scan event, a weighted item event, a voided item event, a price override event, type of tender event, an awaiting manager approval event, a customer identification card presented or verified event, etc. Each action/state can be identified from transaction events raised during the transaction.

Furthermore, each item's states within the transaction (intra transaction) are linked together as an overall sequence of actions for the item within a given transaction (intra transaction). Each action is assigned probability on a state in which it may occur according to the order of the actions. For example, two actions may include a weighted item event and a void item event, where the item is tomatoes. These may occur at the same state or on a different state, depending on the order of state transitions. Actions on other items are also considered if they are relevant to the examined item. For example, one state may represent the amount of actions between the previous state and the next state. Another state may represent a different item with the exact same weight as the examined item.

The edges of the derived graph (the links between the vertices (actions/states)) are assigned probabilities. The probabilities are calculated based on being in a given state and the observed likelihood of transitioning to a next available state. Observations from transaction logs are used to determine or calculate each probability assigned to a given edge (which represents transitioning from one state to another state). Thus, frequent transitions of an item from a current state to a next state are assigned high probabilities.

The model traverses a given item's states graphs for a given transaction to produce an item non-fraud score for that given item using the probabilities assigned to the edges traversed.

Transaction event logs are evaluated when training/producing the intra transaction item model. The item comprises a state graph, the vertices (nodes) representing the action/state/event being modeled (each action or state corresponding to an event from the event logs), and the edges connecting the nodes represent a transition from one state to another state. The probabilities for transitioning between each state is optimized according to observed cashier sequences in the transaction event logs for the item, thus frequent item action sequences receive higher probabilities than others. Once a cashier action sequence has been optimized, whether it is an observed one or a new one (according to which graph has been constructed or not), the sequence can be traced back on the graph and its item non-fraud score (likelihood) can be computed.

Transaction event logs executed during a configured time frame (such as a day, a week, etc.) can be preprocessed based on domain knowledge associated with a given retailer to determine the item actions/states/events and sequences of actions/states on the item for purposes of accurately training the model to pinpoint sweethearting fraud transactions. Firstly, this domain knowledge can be preprocessed to differentiate between automatic actions and manual actions (voided items, item price overrides). Secondly, an automatic type is assigned to each automatic action and a manual type is assigned to each manual action. For example, a price override at the amount of 100% of the priced item could be granted due to a promotion discount that was not received (automated action type—whereas a price override with no corresponding coupon is assigned a manual action type). In this way, different sub types of actions are labeled and identified from the event logs. Thirdly, standard scanning action is represented by an average time that scanning of an item takes. Other actions can be represented by the actual time taken. Fourthly, certain actions such as awaiting manager approval, tender type used to pay, coupons, etc. are accounted for from the event logs. Fifthly, any suspended transaction action is combined as one action with its corresponding reactivate or recall action. Thus, there is a linkage between suspending and recalling transactions.

The preprocessed events for the transaction are aggregated to create a sequence of actions per item. The states' graph can be represented by a Probabilistic Graphical Model (PGM), a recurrent Neural Network (NN), or any other algorithm that can process a series and emit a single item non-fraud score for a provided item of a transaction (represented by the item state transitions (item event transitions)). In an embodiment, a Hidden Markov Model (HMM) was implemented as a statistical model that assumes a Markov Process over time, i.e., that the likelihood of a state Y depends only on the preceding state X. Thus, when computing the HMM, a states' graph is generated, such that each state may emit one of the observations in the sequence with the inferred probability. For example, in one state a standard item scan may be emitted with a probability of 0.90 while in another state that mainly represents weighted items, an item scan may be emitted with a probability of 0.01. In addition, the probability to move from one state to another state is computed. Eventually, when the model is constructed, a new sequence of events for an item of a given transaction as well as the transitions between the events (states) can be run across the graph to compute the probabilities of the sequence of events as well as the transitions between them, which in turn could be used to calculate the likelihood function for an item's state sequence within a new transaction. The HMM is trained over numerous historical sequences. To gain optimal inference, thousands of sequences are processed, and the number of states in the states' graph, along with the item and emission probabilities are optimized. If one sequence is prevalent, it is probably highly likely compared to other sequences and therefore will receive a high item non-fraud score (likelihood score), whereas a rare sequence will gain an exceptionally low item non-fraud score (likelihood score) and could indicate a cashier that is putting the retailer at risk with sweethearting fraud.

Since the final output of the model is a log-likelihood item non-fraud score, the summation of these scores across all transactions for a given cashier can be summed to representing the overall cashier activity. This in turn can be used to compare between cashiers on different Point-Of-Sale (POS) terminals or at different times of day. The summation can be associated with a cashier-maintained profile and utilized with other metrics maintained for the cashier, such as totals for price overrides, transaction voids, etc. The cashier profile may detail different totals and scores and combined to give a cashier an overall score that can be compared and contrasted against other cashiers.

Moreover, threshold values may be set by a retailer for a given transaction, such that an alert can be raised in real time for a transaction that has an extremely low item non-fraud score, which falls below the retailer-set threshold. A manager may be dispatched based on the alert to perform a real-time audit of the suspicious transaction.

Thus, system 100 and the techniques that follow evaluate the sequences of item state transactions within a given transaction for scoring the item state sequences and produce an item non-fraud score per item of the given transaction. All of the item non-fraud scores of a given transaction may further be combined to produce an overall transaction non-fraud score for a given transaction. The item non-fraud scores and/or transaction non-fraud score can be integrated into a retailer's existing fraud detection capabilities and/or used in real time for purposes of providing a contextual based fraud assessment on a per cashier and per transaction basis.

It is within this context system 100 is discussed.

System 100 comprises a cloud/server 110, a plurality of transaction terminals 130, and one or more retail servers 120.

Cloud/Server 110 comprises at least one processor 111 and a non-transitory computer-readable storage medium 112. Medium 112 comprises executable instructions for a sweethearting fraud manager 113, one or more machine-learning models (algorithms) 114, and a trainer 115. The executable instructions when executed by processor 111 from the medium 112 cause processor 111 to perform operations discussed herein and below with sweethearting fraud manager 113, model(s) 114, and trainer 114.

Each transaction terminal 120 comprises a processor 121 and a non-transitory computer-readable storage medium 122. Medium 122 comprises executable instructions for a transaction manager 123 and an event agent 124. The executable instructions when executed by processor 121 from medium 122 cause processor 121 to perform operations discussed herein and below with respect to transaction manager 123 and event agent 124.

Each retail server 130 comprises a processor 131 and a non-transitory computer-readable storage medium 132. Medium 132 comprises executable instructions for a transaction manager 133 and fraud detection system 134. The executable instructions when executed by processor 131 from medium 132 cause processor 131 to perform operations discussed herein and below with respect to transaction manager 133 and fraud detection system 134.

Initial training of model 113 is based on an event logs for each cashier (terminal operator who performs checkouts of customers within a store of a given retailer). During training transaction types are identified for each transaction's events. Each event representing a state transitioned to during a given transaction.

Trainer 115 provides preprocesses and labels event information from the invent log to model 114 to identify the cashier, label item actions as automatic or manual with an action type (as discussed above), provide a standard time for a standard scan action, identify actual action time, and combine transaction suspension events with the corresponding recall events. The preprocessed data and events are provided as input to model 114. Model 114 receives all of the training data and then calculates by item and by event or state a probability for each next state that a given state can transition to. Each set of events per item and per transaction is then assigned an item non-fraud score based on the actual sequence of item events/states for that transaction. Model 114 may also provide a single transaction non-fraud score for the transaction based on each of the item non-fraud scores computed for each item of the transaction.

In an embodiment, model 114 is an HMM that infers the item states and the transitions from the training data.

Once trained, model 114 can be provided item events for an item during a transaction, calculate probabilities associated with transitioning between each item state that was traversed during the transaction and provide as output an item non-fraud score (likelihood score) per item of the transaction, and optionally, output a single transaction non-fraud score based on the item non-fraud scores of the transaction.

After training of model 114, system 100 may operate as follows. A given cashier performs a transaction on terminal 130. Event agent 134 provides the item events in real time to sweethearting fraud manager 113 and/or after the transaction completes. Sweethearting fraud manager 113 inspects the item events and preprocesses to assign automatic or manual action types to each item action, identify the standard times for a standard scan action, obtain actual time for other actions, account for any non-standard actions (such as awaiting manager approval, tender type used to pay), combine any suspended states with recall states, and sweethearting fraud manager 113 provides the preprocessed data and events directly to model 114 as input. Model 114 returns item non-fraud scores or likelihood scores for each item of the transaction and, optionally, a single transaction non-fraud score for the transaction as a whole based on the computed item non-fraud scores. Sweethearting fraud manager 113 may evaluate each of the item non-fraud scores and/or the single transaction non-fraud score against any retailer set threshold(s) and raise an alert to fraud detection system 124. Assuming no alert is raised, the item non-fraud scores (and single transaction non-fraud score) for the cashier, the items of the transaction, and the transaction as a whole are provided to fraud detection system 124 for inclusion in a fraud profile associated with the cashier. Fraud detection system 124 may combine abnormal transaction totals for the cashier with the item and transaction non-fraud scores for all transactions of the cashier within the fraud profile. Fraud detection system 124 may also evaluate in real time the received item non-fraud scores for current items of the current transaction against the current abnormal transaction totals for the cashier and based on rules determine whether the cashier should be monitored more closely or visited in real time for an audit of the transaction that most recently completed.

Transaction manager 133 interacts with transaction manager 123 to perform transaction processing, such as item lookups, item pricing, item discounts, loyalty processing, payment processing, returns, etc.

Model 144 self trains and adjusts itself over time as more items associated with more transactions and item events/states and frequencies of item state transitions are noted, such that is no need to undergo a comprehensive training following the initial training. Thus, system 100 is self-learning, adaptable, and self-sustaining following the initial training session.

In an embodiment, event agent 134 obtains the events for a given item of a transaction from an event log and reports the item events for the transaction to sweethearting fraud manager 113.

In an embodiment, event agent 134 monitors transaction processing by transaction manager 133 and accumulates the item events in sequential order and reports the set of item events when a transaction complete event is detected from transaction manager 133.

In an embodiment, transaction terminal 130 is a Point-Of-Sale (POS) terminal, a Self-Service Terminal (SST), or a kiosk.

In an embodiment, sweethearting fraud manager 113, model 114, and trainer 115 may be subsumed into and executed on retailer server 120.

In an embodiment, transaction manager 123 and/or fraud detection system 124 may be subsumed into and executed on cloud/server 110.

In an embodiment, sweethearting fraud manager 113, model 114, and trainer 115 is provides as a Software as a Service (SaaS) to a given retailer.

In an embodiment, sweethearting fraud manager 113 can be run in a batch mode at the end of each data or other preconfigured interval of time, in which the item event logs for the interval of time are provided and the item non-fraud scores for each transaction during the interval returned back to fraud detection system 124. Fraud detection system 124 may link identified fraudulent transactions of a given retailer to video clips of security video for visually auditing suspect transactions.

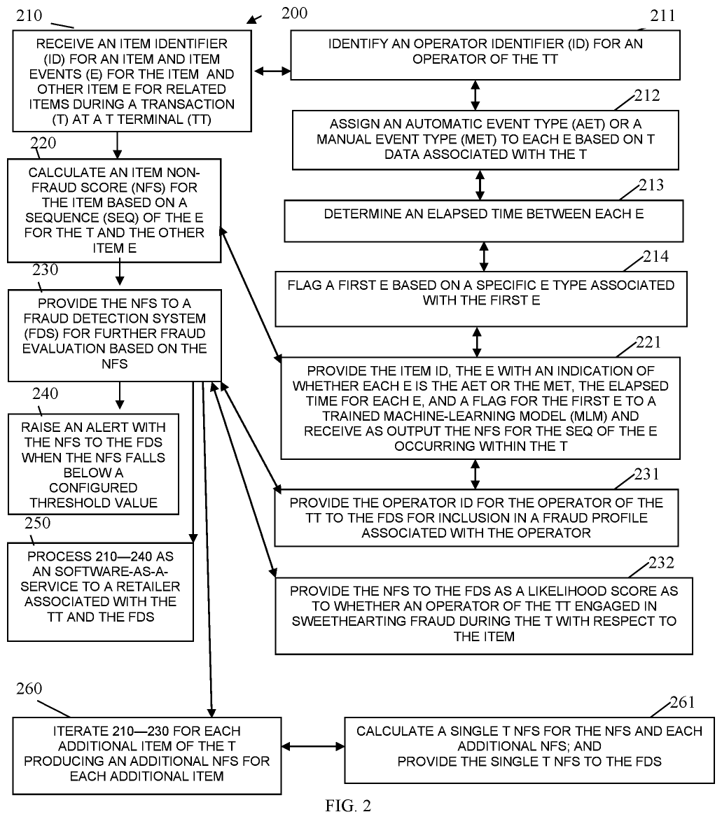

The above-referenced embodiments and other embodiments are now discussed with reference to FIG. 2.

FIG. 2 is a diagram of a method 200 for intra transaction item-based sequence modeling for fraud detection, according to an example embodiment. The software module(s) that implements the method 200 is referred to as an “item sequence fraud assessor.” The item sequence fraud assessor is implemented as executable instructions programmed and residing within memory and/or a non-transitory computer-readable (processor-readable) storage medium and executed by one or more processors of one or more devices. The processor(s) of the device(s) that executes the item sequence fraud assessor are specifically configured and programmed to process the item sequence fraud assessor. The item sequence fraud assessor has access to one or more network connections during its processing. The connections can be wired, wireless, or a combination of wired and wireless.

In an embodiment, the device that executes the item sequence fraud assessor is cloud 110. In an embodiment, the device that executes item sequence fraud assessor is server 110.

In an embodiment, the item sequence fraud assessor is all of, or some combination of sweethearting fraud manager 113, model(s) 114, and/or trainer 115.

At 210, item sequence fraud assessor receives an item identifier for an item and item events for the item and other item events for related items during a transaction at a transaction terminal 130.

In an embodiment, at 211, the item sequence fraud assessor identifies an operator identifier for an operator of the transaction terminal 130.

In an embodiment of 211 and at 212, the item sequence fraud assessor assigns an automatic event type or a manual event type to each item event based on transaction data associated with the transaction. For example, a price override event may be associated with a coupon applied event within the transaction data, such that the price override item event is assigned an automatic event type. Conversely, an item price override event that lacks any corresponding coupon within the transaction data is assigned a manual event type.

In an embodiment of 212 and at 213, the item sequence fraud assessor determines an elapsed time between each item event. This identifies the operator time between actions or by inference the time of a given operator action on the item.

In an embodiment of 213 and at 214, the item sequence fraud assessor flags a first item event based on a specific item event type associated with the first item event. For example, the item events may include a first item event associated with a specific item event type for awaiting management approval, such a situation may skew the elapsed times and is accounted for with a flag.

At 220, the item sequence fraud assessor calculates an item non-fraud score for the item based on an item sequence of the item events for the transaction and the other item events.

In an embodiment of 214 and 220, at 221, the item sequence fraud assessor provides the item identifier, the item events along with an indication of whether each item event is the automatic event type or the manual event type, the elapsed time for each event to transition to the next event in the item sequence, and the flag produced at 214 to a trained machine-learning model 114. The item sequence fraud assessor receives as output the item non-fraud score for the item sequence of the item events occurring within the transaction. The item non-fraud score is assigned to the item of the transaction and represents a likelihood score that the item was or was not associated with sweethearting fraud by the operator who performed the transaction on the transaction terminal 130.

At 230, the item sequence fraud assessor provides the item non-fraud score to a fraud detection system 124 for further sweethearting fraud evaluation based on the item non-fraud score.

In an embodiment of 221 and 230, at 231, the item sequence fraud assessor provides the operator identifier for the operator of the transaction terminal to the fraud detection system 124 for inclusion in a fraud profile associated with the operator.

In an embodiment, at 232, the item sequence fraud assessor provides the item non-fraud score to the fraud detection system 124 as a likelihood score as to whether an operator of the transaction terminal engaged in sweethearting fraud during the transaction with respect to the item.

In an embodiment, at 240, the item sequence fraud assessor raises an alert with the item non-fraud score to the fraud detection system 124 when the item non-fraud score falls below a configured threshold value.

In an embodiment, at 250, the item sequence fraud assessor is provided and processed as a Software-as-a-Service (SaaS) to a retailer associated with the transaction terminal 130 and the fraud detection system 124.

In an embodiment, at 260, the item sequence fraud assessor iterates 210-230 for each additional item of the transaction producing an additional item non-fraud score for each additional item.

In an embodiment of 260 and at 261, the item sequence fraud assessor calculates a single transaction non-fraud score for the item non-fraud score and each additional item non-fraud score. The item sequence fraud assessor provides the single transaction non-fraud score to the fraud detection system 124.

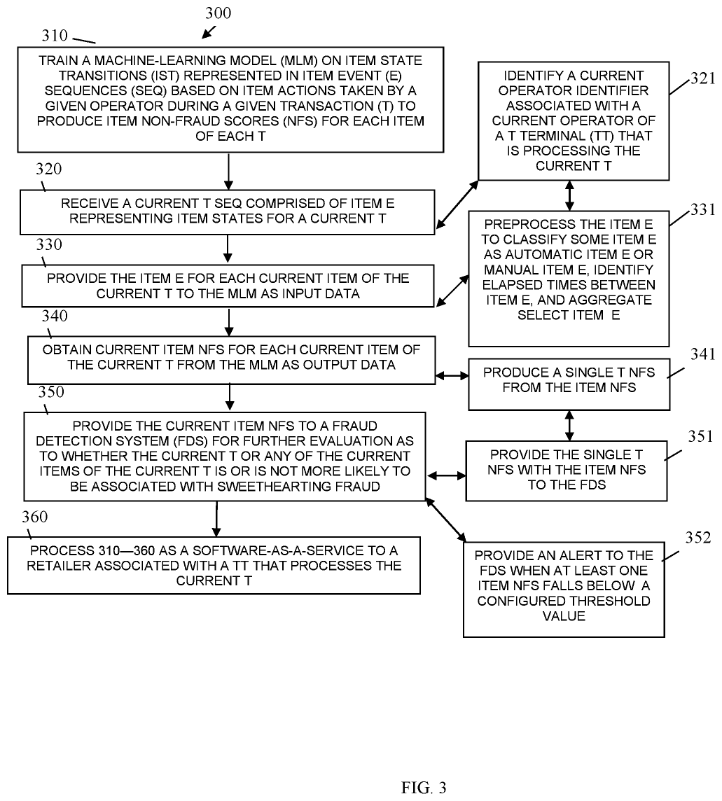

FIG. 3 is a diagram of another method 300 for intra transaction item-based sequence modeling for fraud detection, according to an example embodiment. The software module(s) that implements the method 300 is referred to as a “item sequence-based fraud scorer.” The item sequence-based fraud scorer is implemented as executable instructions programmed and residing within memory and/or a non-transitory computer-readable (processor-readable) storage medium and executed by one or more processors of one or more devices. The processor(s) of the device(s) that executes the item sequence-based fraud scorer are specifically configured and programmed to process the item sequence-based fraud scorer. The item sequence-based fraud scorer has access to one or more network connections during its processing. The network connections can be wired, wireless, or a combination of wired and wireless.

In an embodiment, the device that executes the item sequence-based fraud scorer is cloud 110. In an embodiment, the device that executes the item sequence-based fraud scorer is server 110.

In an embodiment, the item sequence-based fraud scorer is all of, or some combination of sweethearting fraud manager 113, model(s) 114, trainer 115, and/or method 200.

The item sequence-based fraud scorer presents another and, in some ways, enhanced processing perspective from that which was discussed above with the method 200 of the FIG. 2.

At 310, the item sequence-based fraud scorer trains a machine-learning mode on item state transitions represented in item event sequences based on item actions taken by a given operator during a given transaction to produce item non-fraud scores for each item of each transaction.

In an embodiment, at 320, the the item sequence-based fraud scorer receives a current transaction sequence comprised of item events representing item states for a current transaction.

In an embodiment, at 321, the the item sequence-based fraud scorer identifies a current operator identifier associated with a current operator of a transaction terminal 130 that is processing the current transaction.

At 330, the the item sequence-based fraud scorer provides the item events for each current item of the current transaction to the machine-learning model as input data.

In an embodiment of 321 and 330, at 331, the the item sequence-based fraud scorer preprocesses the item events to classify some item events as automatic item events or manual item events, identifies elapsed times between item events, and aggregate select item events (suspended events and recall events are aggregated into a single combined item event). The preprocessed information is provided with the item events for each current item as the input data to the machine-learning model.

At 340, the the item sequence-based fraud scorer obtains current item non-fraud scores for each current item of the current transaction from the machine-learning model as output data.

In an embodiment, at 341, the the item sequence-based fraud scorer provides a single transaction non-fraud score from the item non-fraud scores.

At 350, the the item sequence-based fraud scorer provides the current item non-fraud scores to a fraud detection system 124 for further evaluation as to whether the current transaction or any of the current items of the current transaction is or is not more likely to be associated with sweethearting fraud.

In an embodiment of 341 and 350, at 351, the the item sequence-based fraud scorer provides the single transaction non-fraud score with the item non-fraud scores to the fraud detection system 124.

In an embodiment, at 352, the the item sequence-based fraud scorer provides an alert to the fraud detection system 124 when at least one item of the current items for the current transaction falls below a configured threshold value.

In an embodiment, at 360, the the item sequence-based fraud processes and is provided as a SaaS to a retailer associated with a transaction terminal 130 that processes the current transaction.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving an item identifier for an item and item events for the item and other item events for related items during a transaction at a transaction terminal;
calculating an item non-fraud score for the item based on a sequence of the events for the transaction; and
providing the item non-fraud score to a fraud detection system for further fraud evaluation based on the item non-fraud score.

2. The method of claim 1 further comprising, raising an alert with the item non-fraud score to the fraud detection system when the item non-fraud score falls below a configured threshold value.

3. The method of claim 1 further comprising, processing the method as a Software-as-a-Service (SaaS) to a retailer associated with the transaction terminal and the fraud detection system.

4. The method of claim 1 further comprising, iterating the method for each additional item of the transaction producing an additional item non-fraud score for each additional item.

5. The method of claim 4 further comprising:
calculating a single transaction non-fraud score from the item non-fraud score and each additional item non-fraud score; and
providing the single transaction non-fraud score to the fraud detection system.

6. The method of claim 1, wherein receiving further includes identifying an operator identifier for an operator of the transaction terminal.

7. The method of claim 6, wherein identifying further includes assigning an automatic event type or a manual event type to each item event based on transaction data associated with the transaction.

8. The method of claim 7, wherein assigning further includes determining an elapsed time between each item event.

9. The method of claim 8, wherein determining further includes flagging a first item event based on a specific item event type associated with the first event.

10. The method of claim 9, wherein calculating further includes providing the item identifier, the item events with an indication of whether each item event is the automatic event type of the manual event type, the elapsed time for each item event, and a flag for the first event to a trained machine-learning model as input and receiving as output from the trained machine-learning model the item non-fraud score for the sequence of the item events occurring within the transaction.

11. The method of claim 10, wherein providing further includes providing the operator identifier for the operator of the transaction terminal to the fraud detection system for inclusion in a fraud profile associated with the operator.

12. The method of claim 1, wherein providing further includes providing the item non-fraud score to the fraud detection system as a likelihood score as to whether an operator of the transaction terminal engaged in sweethearting fraud during the transaction with respect to the item.

13. A method, comprising:
training a machine-learning model on item state transitions represented in item event sequences based on item actions taken by a given operator during a given transaction to produce item non-fraud scores for each item of each transaction;
receiving a current transaction sequence comprised of item events representing item states for a current transaction;
providing the item events for each current item of the current transaction to the machine-learning model as input data;
obtaining current item non-fraud scores for each current item of the current transaction from the machine-learning model as output data; and
providing the current item non-fraud scores to a fraud detection system for further evaluation as to whether the current transaction or any of the current items of the current transaction is or is not more likely to be associated with sweethearting fraud.

14. The method of claim 13, wherein receiving further includes identifying a current operator identifier associated with a current operator of a transaction terminal that is processing the current transaction.

15. The method of claim 14, wherein providing the item events further includes preprocessing the item events to classify some item events as automatic item events or manual item events, identify elapsed times between the item events, and to aggregate select item events.

16. The method of claim 13, wherein obtaining further includes producing a single transaction non-fraud score from the item non-fraud scores.

17. The method of claim 13, wherein providing the current item non-fraud scores further includes providing an alert to the fraud detection system when at least one item non-fraud score falls below a configured threshold value.

18. The method of claim 13 further comprising, processing the method as a Software-as-a-Service (SaaS) to a retailer associated with a transaction terminal that processes the current transaction.

19. A system, comprising:
a cloud server comprising at least one processor and a non-transitory computer-readable storage medium;
the non-transitory computer-readable storage medium comprises executable instructions;
the executable instructions when provided to and executed by the at least one processor from the non-transitory computer-readable storage medium cause the at least one processor to perform operations comprising:
receiving a transaction sequence of events for a transaction processed on a transaction terminal, wherein the transaction sequence comprises a plurality of item sequences for item events associated with each item of the transaction;
assigning an item event type to each item event for each item to an automatic classification or a manual classification;
determining elapsed times between each item event of each item sequence for each item;
aggregating select transaction events producing aggregated events;
for each item sequence providing the the corresponding item events along with the corresponding automatic classification or the manual classification, the corresponding elapsed times, and the aggregated events to a trained machine-learning model as input data;
for each item sequence associated with each item receiving as output from the trained machine-learning model an item non-fraud score that is based on assigned probabilities for transitions between the corresponding item events of the corresponding item sequence for the corresponding item; and
providing the item non-fraud scores for the items of the transaction to a fraud detection system for further evaluation of any sweethearting fraud that may be associated with an operator who performed the transaction on a transaction terminal.

20. The system of claim 19, wherein the executable instructions are accessible as a Software-as-a-Service (SaaS) to a retailer server associated with a retailer of the transaction terminal that processes the transaction.
